(19) United States
(12) Patent Application Publication
(10) Pub. No.: US 2010/0017177 A1
(43) Pub. Date: Jan. 21, 2010

(54) Method of Predicting and Exhibiting Energy Usage for a Plurality of Buildings

(76) Inventor: Lawal Adetona Dosunmu, Moorestown, NJ (US)

Correspondence Address: Law Office of Michael J. Feigin, 103 The Circle, (http://PatentLawNY.com), Passaic, NJ, 07055, US

(21) Appl. No.: 12/176,451

(22) Filed: Jul. 21, 2008

(51) Int. Cl. G06F 17/50

(52) U.S. Cl. 703/6

(57) ABSTRACT

The invention disclosed comprises a device and method for predicting energy usage for a plurality of buildings. Such a prediction is made by acquiring a plurality of building descriptors from at least two descriptor databases for each building of the plurality of buildings. At least one acquired building descriptor is converted into a data format pre-designated for use with an energy calculator and entered into an energy calculator. A prediction of energy usage and at least one building descriptor, such as an address, is exhibited for at least one building. An estimated cost of providing energy for the at least one building may also be calculated.

### BACKGROUND OF THE INVENTION

Numerous energy calculators exist for estimating energy requirements of a building. In short, such systems function by receiving parameters about an existing or planned building and determining how much energy will be required to heat or cool such a structure. Systems may also determine loads used by the building, such as an electrical load. These systems typically require the manual entry of building parameters and calculate, for example, how much energy will be required to maintain a building within a range of temperatures or an estimated cost of doing so.

The U.S. Department of Energy, as an example, maintains “The Home Energy Saver” website at hes.lbl.gov (accessed Jun. 18, 2008). On this website, a user can enter data such as an address, type of heating equipment, and how many appliances are used, to determine the cost of heating the home if more efficient systems are used. Further, U.S. Pat. No. 6,134,511 to Subbarao discloses a method and apparatus for accurately calibrating building energy simulations by adjusting the heat flow as found in real world measurements.

However, these and other prior art solutions for estimating energy requirements demand a large amount of manual labor, as a user must gather the information, enter it into the simulation, and then provide further data to adjust the measurements. Well, this may be practical for an individual such as a homeowner or builder to do for a single building, but it is not practical to proceed with manual entry and adjustment for a large number of buildings. Further, users do not always have the best information available at their disposal.

Thus, present energy calculation methods have limited usage, and there is a long-felt and unsolved need to link energy usage to prices of real estate in an automated fashion which has not been accomplished in the prior art.

### SUMMARY OF THE INVENTION

It is therefore an object of the invention to provide an automated method of calculating energy requirements for a plurality of buildings.

It is a further object of the invention to obtain data from a plurality of sources, in order to aid in the automation of the calculation of energy requirements.

It is a further object of the invention to select databases where building descriptors may be gleaned, and automatically gleaning such information for purposes of determining energy requirements of a building.

It is still a further object of the invention to provide a method and apparatus for the calculating of energy requirements and exhibiting such requirements along with building information. Such a display may be used for cities to locate areas where energy usage could be decreased, real estate professionals and buyers and sellers to aid in advertising, or appraising buildings based on energy costs, and the like.

In embodiments of the method of the invention, a prediction of energy usage for a plurality of buildings is estimated by acquiring a plurality of building descriptors from at least two descriptor databases for each building of the plurality of buildings. A descriptor database may be a real estate database, a city database, a satellite photograph database, or other databases comprising building data information. At least one acquired building descriptor is converted into a data format pre-designated for use with an energy calculator. At least one building descriptor, or all relevant building descriptors are entered into an energy calculator, and the energy calculator may be programmed specifically for use with the present invention or used in the art for predicting energy usage and the like, and a prediction of energy usage and at least one building descriptor, such as an address, is exhibited for at least one building. An estimated cost of providing energy for the at least one building may also be calculated and this cost may be exhibited.

The converting may comprise converting graphical data into shape data. This may take place when a descriptor database comprises satellite imagery and a picture of a house is used to determine the shape of the house, wherein the shape of the house may comprise the size, layout, orientation, or other features of the house.

The steps of receiving, converting, entering, and exhibiting may each or all be automated and may further comprise a step of receiving a manually entered building descriptor.

A device for at least partially automating a prediction of energy usage for a plurality of buildings is also disclosed herein. The device comprises a collating device for receiving a plurality of building descriptors for each building of the plurality of buildings wherein the plurality of building descriptors are received from at least two descriptor databases, a converter for reading at least one descriptor of the plurality of building descriptors and converting the at least one descriptor into a data format pre-designated for use with an energy calculator, a data entry device for entering at least a portion of the plurality of building descriptors into an energy calculator; and a display device for exhibiting the prediction and at least one building descriptor for at least one building of the plurality of buildings.

### BRIEF DESCRIPTION OF THE DRAWINGS

FIG. 1 shows a method of predicting energy usage for a plurality of buildings in an embodiment of the invention.

FIG. 2 shows a high level diagram of a method for extracting descriptors from a plurality of databases.

FIG. 3A shows an illustration of map data as part of a descriptor database as used in an embodiment of the invention.

FIG. 3B shows individual descriptors of a building shown in FIG. 3A.

FIG. 4 shows a high level block diagram of a device for predicting energy usage which is used in an embodiment of the invention.

FIG. 5 shows an example of an exhibition of an energy prediction in an embodiment of the invention.

FIG. 6 shows a high level block diagram of a device on which aspects of the invention may be carried out.

### DETAILED DESCRIPTION OF THE EMBODIMENTS

The invention disclosed comprises a device and method for predicting energy usage for a plurality of buildings. Such a prediction is made by acquiring a plurality of building descriptors from at least two descriptor databases for each building of the plurality of buildings. A descriptor is any item, value, or data which describes an aspect of a building or other structure made by man or natural forces. A descriptor database is a database comprising at least one descriptor. A descriptor database may be a real estate database, a city database, a satellite photograph database, or other databases comprising building data information. A descriptor may also be extrapolated or calculated based on data from two prior descriptors.

At least one acquired building descriptor is converted into a data format pre-designated for use with an energy calculator. An energy calculator may be located at the place (i.e., a physical location or on a device) where the method of the invention is carried out or may be connected via a network connection. The energy calculator may be administered by a separate entity and be separate from a device of the invention. At least one building descriptor, or all relevant building descriptors are entered into an energy calculator, and the energy calculator may be programmed specifically for use with the present invention or used in the art for predicting energy usage and the like, such as a pre-existing energy calculator, and a prediction of energy usage and at least one building descriptor, such as an address, is exhibited for at least one building. An estimated cost of providing energy for the at least one building may also be calculated and this cost may be exhibited.

Embodiments of the invention will become clear with respect to the following description of figures.

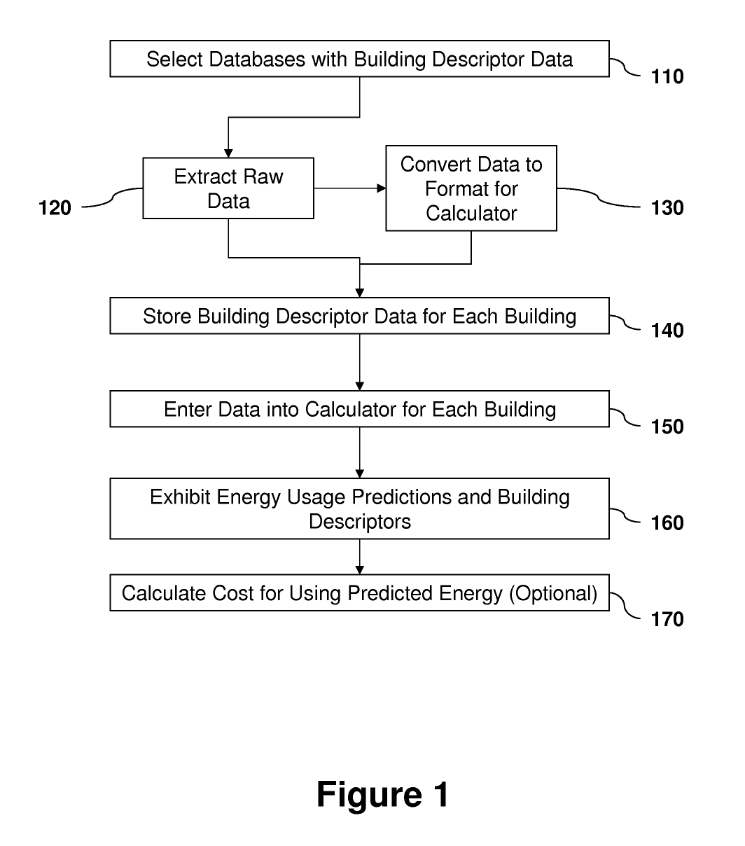

FIG. 1 shows a method of predicting energy usage for a plurality of buildings in an embodiment of the invention. In step 110, databases are selected which comprise building descriptor data. Such databases may comprise a real estate database (i.e. a database of properties for sale or rent), a town or other government entity database, or a map database such as a pictorial, land use, or satellite database. Any database comprising building descriptors may be used in embodiments of the invention. Such databases may be maintained by another entity, such as with a public records database, a private real estate agency, or by an entity carrying out embodiments of the invention.

In step 120, raw data is extracted from one or a plurality of descriptor databases. An additional optional step comprises manually providing data, such as when necessary data cannot be extracted from a descriptor database or is otherwise unavailable. Examples of descriptors which may be used in embodiments of the invention comprise location information such as a street address, city, state, zip code, coordinates (longitude and latitude), elevation, and the like. Other examples are climate data and building characteristics data, such as the year it was built, floor space, square feet, shape, orientation (i.e., facing south or north), length, width, weather stripping, window ratings, number of windows, insulation information, skylights, and the like. The number of occupants and their ages may also be taken into account. Further, information about the climate control systems, such as the cooling and heating systems may be gleaned. This may include the type of systems, capacity, energy efficiency, number of fans, hours per day used, and the like. The price of energy in the area may also be obtained from a descriptor or other database in this step.

In some cases, a gleaned building descriptor extracted in step 120 can be directly stored in a database in step 140. However, in other cases, the data must be converted, in step 130, so that it may be used to estimate energy usage, such as in an energy calculator.

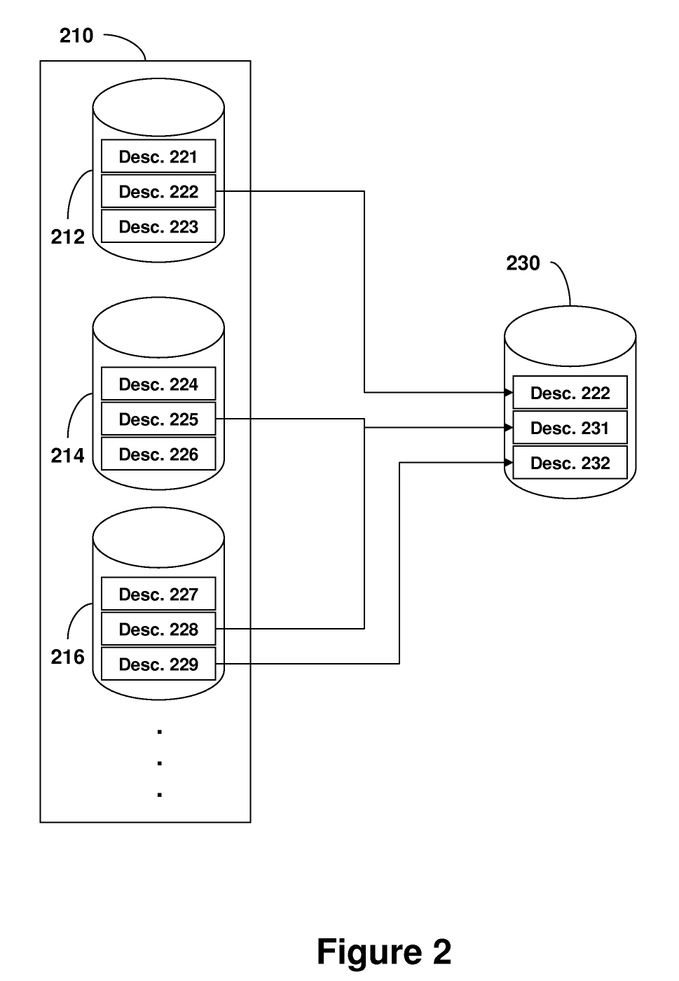

Referring now to FIG. 2, this figure shows a high level diagram of a method of extracting descriptors from a plurality of databases. When carrying out steps 110 to 140, of FIG. 1, descriptor databases 210, comprising databases 212, 214, and 216, may be used as sources of descriptors. More descriptor databases than are shown in the figure may be used. Descriptor database 212, by way of illustration, comprises descriptors 221, 222, and 223. Descriptor database 214, by way of illustration, comprises descriptors 224, 225, and 226. Descriptor database 216, by way of illustration comprises descriptors 227, 228, and 229. Each database may comprise many more descriptors than are shown.

Descriptor database 212, may, for example, be a real estate database and the descriptors may be a street address 221, a zip code 222, and a sale price 223. Descriptor database 214, may, for example, be a city records database and a record for a building may comprise year built information 224, a square footage 225, and a tax assessment 226. Descriptor database 216, may, for example, be a satellite map database providing an image of the building. The descriptors may be an address 227, shape data 228, and a picture 229.

Database 230 is a receiving database used for collating the descriptors and may be on a system used for carrying out the function of converting the descriptors for use with an energy calculator and entering the descriptors into an energy calculator.

Referring now to FIGS. 1 and 2 concurrently, in the above example, descriptor database 210, a real estate database, such as a database of homes for sale, may be selected in step 110. Descriptor 222, a zip code, may be extracted in step 120 (raw data, in this step, refers to any data extracted from such a database before processing thereof in step 130). In this instance, the zip code data is acceptable for entry into database 230, and thus, the method of the invention proceeds directly from step 120 to step 140, such that the building descriptor data is stored in database 230. However, with respect to descriptor 229 which is, in this example, a picture of the building, such as a picture taken from the front of the building by a camera in, or on a vehicle in front of, the property, the data may need to be reworked. For example, an energy calculator may need the image in a specific format or at a specific resolution for processing. Further, an energy calculator may not be able to use a picture (i.e., the raw data extracted in step 120), and the picture must be analyzed to glean shape data (i.e., the shape of the building), height information, or other size information. Still further, the descriptor 229 may not necessarily be used to predict energy requirements, but may, instead, be gleaned for the purposes of exhibiting the descriptor 229 with the energy prediction (see description of step 160, below).

If the data gleaned in step 120 needs to be converted to a format for entry into an energy calculator, then step 130 is carried out wherein the data is converted. Thus, in the present example, descriptor 229 is converted into descriptor 232 and stored in database 230.

In the third example portrayed in FIG. 2, descriptor 225 comprises square footage data as represented in a city records database, and descriptor 229 comprises shape data as gleaned from a satellite map. Data from two descriptors in two different databases may be calculated and converted in step 130 of FIG. 1 to develop a descriptor which is stored in database 230. In this example, descriptor 232 may be an estimate of an area within the building to be heated or cooled, based on gleaning of square footage data and shape data (i.e., the shape of the building which may comprise a layout and a height), so as to automatically or semi-automatically arrive at a descriptor 232 which can be used to more accurately and quickly calculate energy usage than shown in the prior art.

Referring back to FIG. 1, in step 150, the building descriptor data stored is entered into an energy calculator for each building. While the invention may be carried out with regard to one building, the ability to pull data from various descriptor databases, analyze and convert the data automatically or semi-automatically, allows an entire list of buildings to be analyzed and provided along with energy usage predictions. Thus, in step 160, energy usage predictions and building descriptors are exhibited. For example, along with an address of a building or another descriptor which will generally be recognizable to a user as belonging to a specific building, an energy rating may be provided. The energy rating may be a measure of how much energy, or optionally in step 170, how much it will cost to maintain a building at a certain temperature, such as at or near room temperature, over a period of time, such as a month or a year. Exhibiting means that the data is shown to a user either concurrently, such as on a printed page or website, or shown before, such as when a user selects a house or enters further descriptors, or after the amount of energy is exhibited. The prediction of energy usage may be based on the data gleaned from the descriptor databases, manually entered, estimated based on buildings with similar descriptors (such as location, size, or year built), or a combination thereof. The prediction may comprise or be modified by real world measurement data of energy used in a building.

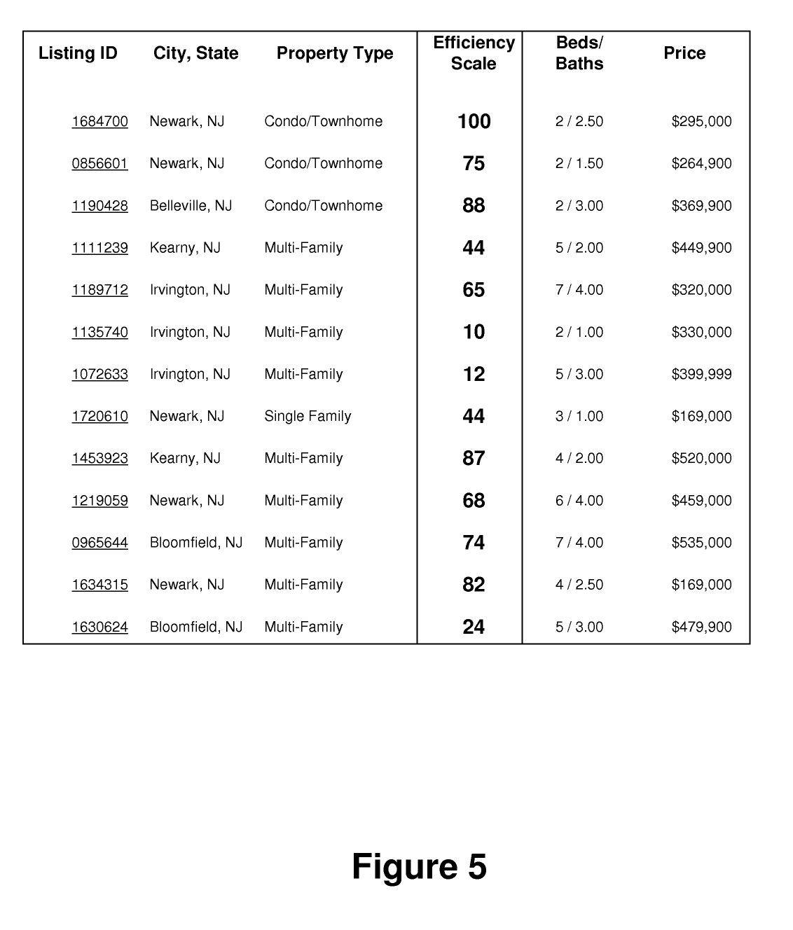

Referring now to FIG. 5, the figure shows an example of an exhibition of an energy prediction in an embodiment of the invention. In this example, which is an exhibition of real estate for sale in the Newark, N.J., region, an energy rating has been provided for each as predicted by embodiments of the invention. Data was taken from the real estate database, and along with an exhibition of descriptors for each house, an estimated energy usage relative to other properties was given on a scale of 1 to 150. In the “Home Energy Ratings System” (HERS), which may be used in embodiments of the invention, 100 represents the energy usage for an “American Standard Building” and 0 represents usage of no net energy. Substantially any efficiency scale known in the art or developed for the present invention may be used. Alternatively, such an exhibition of building descriptors and a prediction of energy usage may comprise an exhibition of energy usage in joules per year, a cost of heating and/or cooling for the year, or the like. It is contemplated and within the scope and spirit of the invention to predict energy usage for substantially any building, based on descriptors gleaned from databases, and providing such a prediction for substantially any exhibition of building information, such as a list of property for sale, city/town records, online or physical maps, or the like. Buyers would be aided and prices could be set taking into account energy efficiency of a dwelling, and homeowners, landlords, and developers will be more cognizant of their energy usage as such usage will have a direct effect on price. Cities will be able to locate areas where a substantial savings to their residents could be achieved based on a realization of low energy efficiency. Thus, the present invention solves a long felt and unsolved need to link energy usage to prices of real estate.

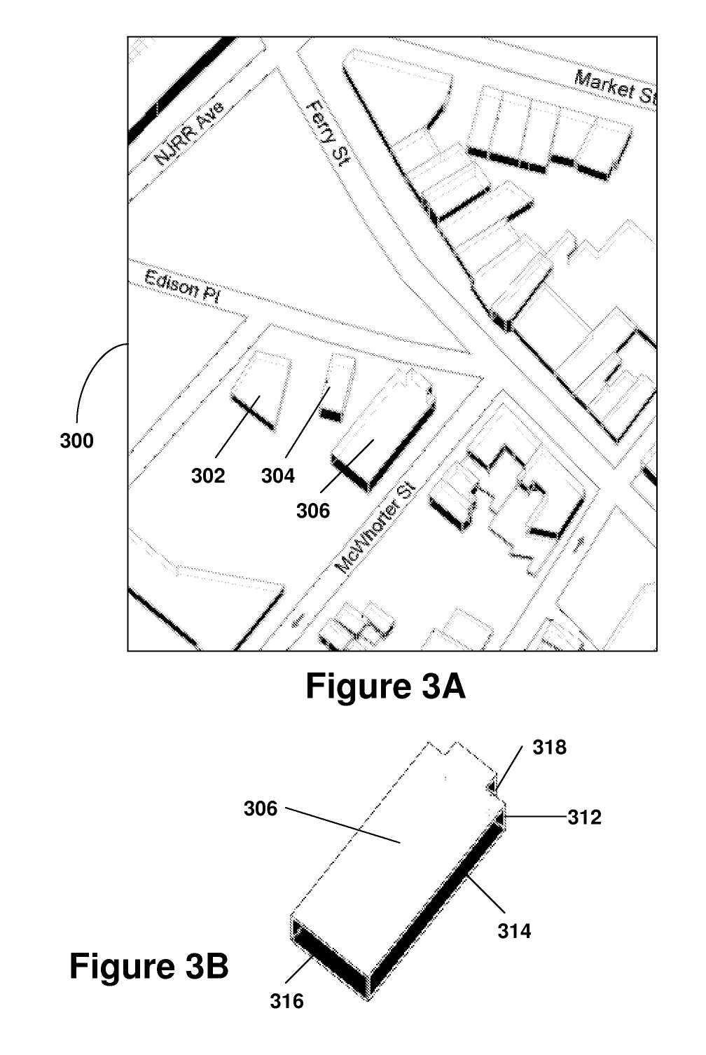

FIG. 3A shows an illustration of map data as part of a descriptor database as used in an embodiment of the invention. The present illustration has been derived from Google Maps presently available at http://maps.google.com, though any map or photo from which a descriptor can be gleaned may be used. The map comprises a three-dimensional view of buildings 302, 304, and 306. Substantially any satellite photograph or map may be interpreted by means known in the art for deriving shape and dimension information from a building. For example, satellite photographs may come with scale data, allowing a device used to carry out the method of the invention to calculate an estimate of an actual size of a building for purposes of determining how much energy is required to maintain the building at the desired temperature throughout the year. Such data may also be used to determine how many days of the year there is cloud cover or shade over a specific building to make a prediction of future energy requirements, or the shape and size of windows or skylights on the building and estimation of energy requirements stemming therefrom.

FIG. 3B shows individual descriptors of a building shown in FIG. 3A. Based on the image of the building derived from satellite imagery (or substantially any picture or a combination of pictures), descriptors are discovered and/or calculated for entry into an energy calculator. FIG. 3B shows a single building 306 whereby a width 316, a length 314, and a height 312 can be garnered from a single image. The height 312 may be used to estimate the number of floors of a building and is helpful because the floors and number of floors impact upon energy usage requirements for a building. Still further, shape data may be gleaned and used to aid in a calculation of energy efficiency. The protruding section 318 will affect energy efficiency differently than the larger, rectangular section. This descriptor data or a combination thereof, for example, with a front picture or descriptors gleaned from other databases, such as window placement, an accurate prediction of energy efficiency can be determined.

Further, descriptors can be garnered from various source descriptor databases for purposes of verification. A street address of a building does not always correspond to the satellite imagery. For example, it may be known that a certain building at a certain address has a certain square footage, but a satellite image does not contain precise enough information to determine which building in the image is the correct building. By making calculation of all buildings which may be the correct building in the satellite imagine, and comparing descriptors, it may be automatically determined which building is the correct building in the satellite image, such as based on the total square footage calculated. In this manner, extraneous data can also be weeded out in order to ensure an accurate prediction of energy usage.

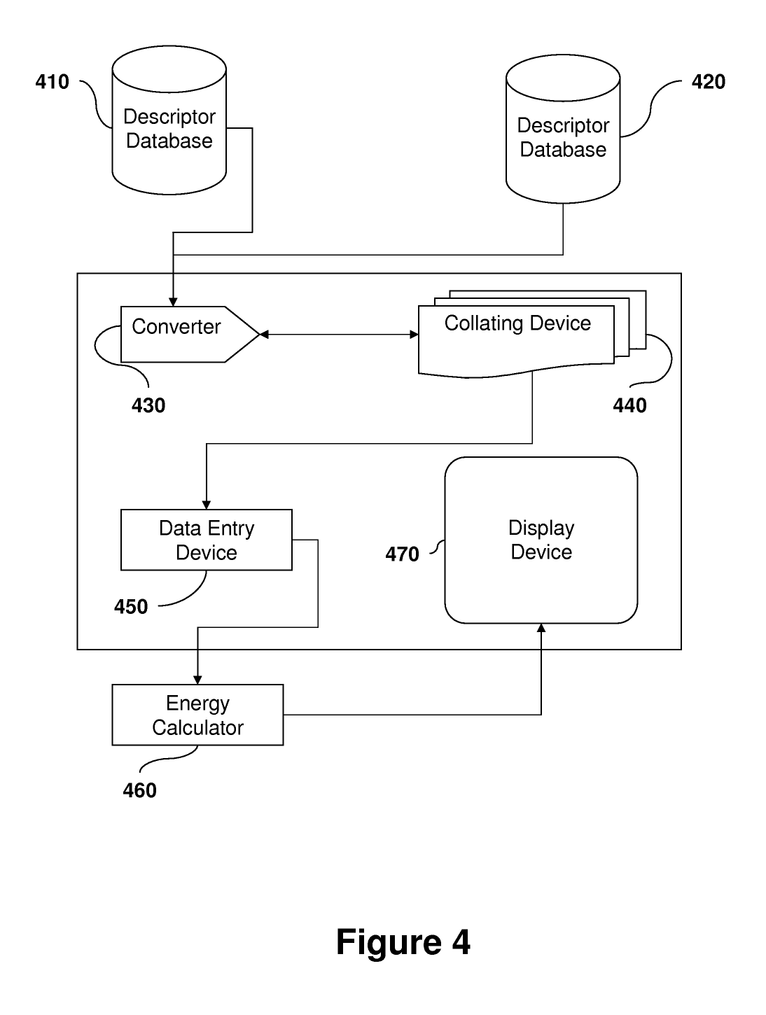

FIG. 4 shows a high level block diagram of a device for predicting energy usage which is used in an embodiment of the invention. Descriptor databases 410 and 420 comprise information about at least one building. In embodiments of the invention, further descriptor databases are used. A converter 430 is a converting device which may be computer implemented and part of a software program for extracting data from the descriptor databases and sending the data to a collating device 440 for storage or further processing. The collating device 440 may further access the converter 330 for the purpose of using multiple descriptors to calculate a new descriptor for use with an energy calculator, such as by the method described above. The converter 430 and collating device 440 may be interchangeable, on the same computing device, or accessed in any order. The converter 330 may also be bypassed. Upon completion of the garnering of descriptor information about one or a plurality of buildings, a data entry device enters the data into an energy calculator. While it has been shown that the energy calculator is on a separate device from the converter 430, collating device 440, and data entry device 450, the energy calculator 450 may be on the same device or a separate device as the preceding elements. The data entry device 450 may be, for example, a computing device configured to read, acquire, or receive descriptors from the collating device 440 and send this data to the energy calculator 460. After the energy calculator 460 determines a measure of energy usage or other calculation related to energy usage of a building, the data may be stored and sent at a later time, or sent to a computing device or other device having a display device 470 which may be a computer monitor, printer, paper and pen, or the like. The display device 470 exhibits at least one building descriptor and the calculated energy usage (i.e., the prediction of energy usage for the building). The display device 470 typically exhibits one or more predictions for a plurality of buildings.

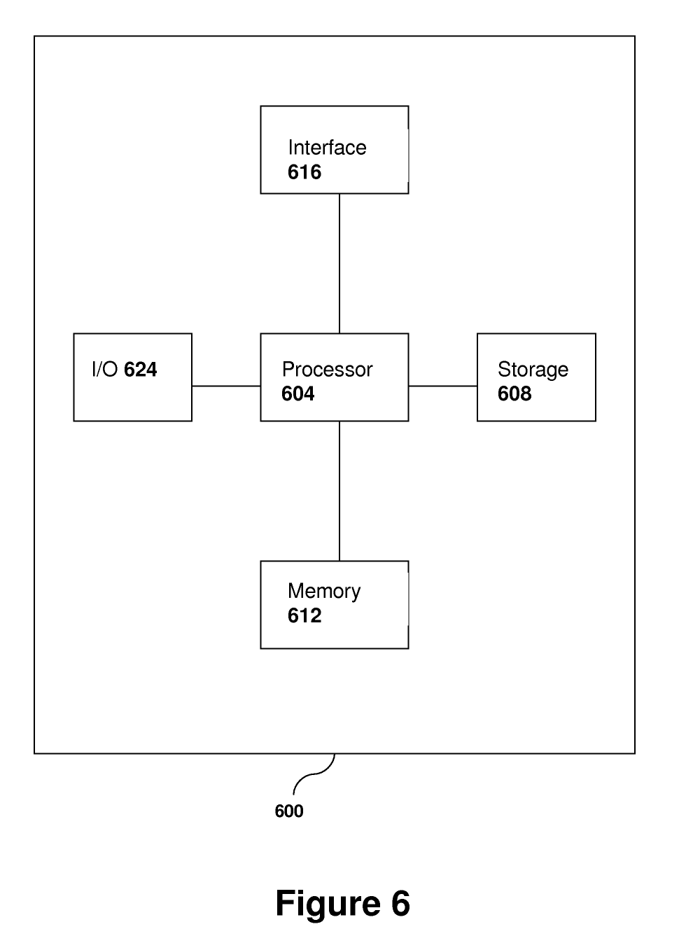

FIG. 6 shows a high-level block diagram of a computer that may be used to carry out the invention. Computer 600 contains a processor 604 that controls the overall operation of the computer by executing computer program instructions which define such operation. The computer program instructions may be stored in a storage device 608 (e.g., magnetic disk, database) and loaded into memory 612 when execution of the computer program instructions is desired. Thus, the computer operation will be defined by computer program instructions stored in memory 612 and/or storage 608, and the computer will be controlled by processor 604 executing the computer program instructions. Computer 600 also includes one or a plurality of input network interfaces for communicating with other devices via a network (e.g., the Internet). Computer 600 also includes one or more output network interfaces 616 for communicating with other devices. Computer 600 also includes input/output 624 representing devices which allow for user interaction with the computer 600 (e.g., display, keyboard, mouse, speakers, buttons, etc.). One skilled in the art will recognize that an implementation of an actual computer will contain other components as well, and that FIG. 6 is a high level representation of some of the components of such a computer for illustrative purposes. It should also be understood by one skilled in the art that the method and devices depicted in FIGS. 1 through 5 may be implemented on a device such as is shown in FIG. 6.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope.

I claim:

1. A method of predicting energy usage for a plurality of buildings comprising:
acquiring a plurality of building descriptors from at least two descriptor databases for each building of said plurality of buildings;
converting at least one said building descriptor into a data format pre-designated for use with an energy calculator;
entering at least one building descriptor into said energy calculator; and
exhibiting a prediction of energy usage and at least one building descriptor for at least one building of said plurality of buildings.

2. The method of claim 1, wherein a cost of providing energy to said at least one building is estimated based on said prediction.

3. The method of claim 2, wherein said cost is exhibited with said prediction and said at least one building descriptor.

4. The method of claim 1, wherein said converting comprises converting graphical data into shape data.

5. The method of claim 1, wherein a descriptor database of said at least two descriptor databases is selected from the group consisting of a real estate database, a satellite photograph database, and a government records database.

6. The method of claim 1, wherein said steps of acquiring, converting, entering, and exhibiting are automated.

7. The method of claim 6, wherein said step of receiving further comprises receiving a manually entered building descriptor.

8. A device for at least partially automating a prediction of energy usage for a plurality of buildings comprising:
a collating device for receiving a plurality of building descriptors for each building of said plurality of buildings, wherein said plurality of building descriptors are received from at least two descriptor databases;
a converter for reading at least one descriptor of said plurality of building descriptors and converting said at least one descriptor into a data format pre-designated for use with an energy calculator;
a data entry device for entering at least a portion of said plurality of building descriptors into an energy calculator; and
a display device for exhibiting said prediction and at least one building descriptor for at least one building of said plurality of buildings.

9. The device of claim 8, wherein a cost of providing energy to said at least one building is estimated based on said prediction.

10. The device of claim 9, wherein said cost is exhibited with said prediction and said at least one building descriptor.

11. The device of claim 8, wherein said converting comprises converting graphical data into shape data.

12. The device of claim 8, wherein a descriptor database of said at least two descriptor databases is selected from the group consisting of a real estate database, a satellite photograph database, and a government records database.

13. The device of claim 8, wherein said descriptors comprise structural information about said at least one building.

14. The device of claim 8, wherein said collating device and said display device are a unitary device.

15. A computer readable storage medium comprising instructions for manipulation of user data, said manipulation comprising:
receiving a plurality of building descriptors from at least two descriptor databases for each building of a plurality of buildings;
converting at least one said building descriptor from each said descriptor database into a data format pre-designated for use with an energy calculator;
entering at least one building descriptor into said energy calculator; and
exhibiting a prediction of energy usage and at least one building descriptor for at least one building of said plurality of buildings.

16. The computer readable storage medium of claim 15, wherein a cost of providing energy to said at least one building is estimated based on said prediction.

17. The computer readable storage medium of claim 16 wherein said cost is exhibited with said prediction and said at least one building descriptor.

18. The computer readable storage medium of claim 15, wherein said converting comprises converting graphical data into shape data.

19. The computer readable storage medium of claim 15, wherein a descriptor database of said at least two descriptor databases is selected from the group consisting of a real estate database, a satellite photograph database, and a government records database.

20. The computer readable storage medium of claim 15, wherein said descriptors comprise structural information about said at least one building.
